(19) United States
(12) Patent Application Publication
(10) Pub. No.: US 2024/0327255 A1
(43) Pub. Date: Oct. 3, 2024

(54) PROCESS FOR COLLECTING AND REMOVING MICROPLASTICS IN WASTEWATER

(71) Applicant: SK INNOVATION CO., LTD., Seoul (KR)

(72) Inventors: Yeon Hwa LA, Daejeon (KR); Jae Yang SONG, Daejeon (KR); Hye Lin ROH, Daejeon (KR)

(21) Appl. No.: 18/621,301

(22) Filed: Mar. 29, 2024

(30) Foreign Application Priority Data
Mar. 31, 2023 (KR) 10-2023-0042554

(51) Int. Cl. C02F 1/463; C02F 1/00; C02F 1/02; C02F 1/461; C02F 3/34; C02F 101/34; C08J 11/10

(52) U.S. Cl. CPC C02F 1/463; C02F 1/02; C02F 1/46109; C02F 3/342; C08J 11/105; C02F 2001/007; C02F 2101/34; C02F 2201/46135; C02F 2201/4614; C02F 2201/4615; C02F 2209/02; C08J 2367/03

(57) ABSTRACT

Proposed is a process for collecting and removing microplastics in wastewater. The process includes coagulating microplastics in wastewater and adding an enzyme to the coagulated microplastics. Also, a method for collecting and removing microplastics is provided, the process comprising: pulverizing polyethylene terephthalate (PET) bottles into microplastics; dispersing the microplastics into a water system; coagulating the microplastics to produce coagulated microplastics; and adding an enzyme to the coagulated microplastics whereby the coagulated microplastics are decomposed by the enzyme into their monomer constituents. According to this process and method, the microplastics in wastewater can be removed with high efficiency.

### CROSS REFERENCE TO RELATED APPLICATION

The present application claims priority to Korean Patent Application No. 10-2023-0042554, filed Mar. 31, 2023, the disclosure of which is incorporated herein by reference in its entirety.

### BACKGROUND OF THE DISCLOSURE

### 1. Background of the Disclosure

The present disclosure generally relates to a process for collecting and removing microplastics in wastewater.

### 2. Description of the Related Art

Used polyethylene terephthalate (PET) bottles are recycled through physical washing process which turns the PET bottles into flakes, and the flakes are used to manufacture fibers. The physical washing process requires a large amount of water. During the process, the PET bottles are pulverized into microplastics, and the microplastics are thus dispersed within the water system.

Wastewater generated during the physical washing process generally undergoes the removal of contaminants such as total organic carbon and total nitrogen through chemical coagulation and biological treatment before being discharged into the nature. In this treatment process, most of the microplastics are collected as coagulated sludge and landfilled without any additional treatment. In other words, microplastics are only collected from the water system and are not removed.

### SUMMARY

Various embodiments of the present disclosure provide a process for collecting and removing microplastics in wastewater.

A process for collecting and removing microplastics in wastewater according to an embodiment of the present disclosure includes: coagulating microplastics in wastewater, and introducing an enzyme to the coagulated microplastics.

According to an embodiment, the wastewater may originate from alkali hot washing treatment of polyethylene terephthalate (PET) plastics.

According to an embodiment, the process may further include heat-treating the wastewater or the microplastics in the wastewater as a pretreatment.

According to an embodiment, the coagulation of the microplastics may be performed by electro-coagulation or adding a coagulant.

According to an embodiment, a cathode used for the electro-coagulation may contain any one selected from stainless steel (SUS), Fe, Al, and Pt, and combinations thereof.

According to an embodiment, an anode used for the electro-coagulation may contain any one selected from Fe and Al, and a combination thereof.

According to an embodiment, the electro-coagulation may be performed at a current density in a range of 5 mA/cm² to 20 mA/cm² for a hydraulic retention time (HRT) of 10 minutes to 30 minutes.

According to an embodiment, the electro-coagulation may be performed at a voltage in a range of 25 V to 200 V for a hydraulic retention time (HRT) of 2 seconds to 30 seconds.

According to an embodiment, the microplastics may have a size in a range of 1 μm to 5 mm based on the longest dimension.

According to an embodiment, the enzyme may include at least one selected from the group consisting of PETases, esterases, lipases, and cutinases.

According to an embodiment, the introduction of the enzymes may be performed at a temperature in a range of 25° C. to 90° C. and under a pressure in a range of 0.5 atm to 2 atm.

According to an embodiment, the weight ratio of PET microplastics in the wastewater inside the electro-coagulator and the enzyme may be in a range of 3:1 or more.

According to an embodiment of the present disclosure, the amount of microplastics in effluent can be minimized by increasing the collection efficiency of the microplastics, and the collected microplastics can be decomposed and removed at the source. In an embodiment PET microplastics in the wastewater after the enzyme treatment, e.g., with an PETase is decomposed to its constituent monomers, e.g., ethylene glycol and terephthalic acid which may then be recovered from the wastewater.

A method for collecting and removing microplastics according to an embodiment of the present disclosure comprising: pulverizing polyethylene terephthalate (PET) bottles into microplastics; dispersing the microplastics into a water system; coagulating the microplastics to produce coagulated microplastics; and adding an enzyme to the coagulated microplastics whereby the coagulated microplastics are decomposed by the enzyme into their monomer constituents.

According to an embodiment, the method further includes: washing the PET bottles with alkali solution at a temperature ranging from 50° C. to 90° C. and a pH ranging from 8-14, preferably 9-10 before pulverizing the PET bottles.

According to an embodiment, the method further includes: heat-treating the microplastics before adding the enzyme to the coagulated microplastics.

A process for decomposing PET microplastics in wastewater into their constituent monomers according to an embodiment of the present disclosure comprising: introducing the wastewater with the PET microplastics in a electro-coagulator and subjecting to PET to electro-coagulation coagulating the PET microplastics inside the wastewater; and adding PETas enzyme into the wastewater inside the electro-coagulator, and the PETase enzyme decomposing the PET coagulated microplastics into their constituent monomers.

According to an embodiment, the process further comprising removing the constituent components of the PET microplastics from the wastewater.

According to an embodiment, the constituent components comprise ethylene glycol and terephthalic acid

### BRIEF DESCRIPTION OF THE DRAWINGS

FIG. 1 is a flow diagram of a process for collecting and removing microplastics in wastewater according to one embodiment.

### DETAILED DESCRIPTION OF THE EMBODIMENTS

The objectives, objects, advantages, and features of the present disclosure will become more apparent from the following detailed description and embodiments, but the present disclosure is not necessarily limited thereto. Additionally, in describing the present disclosure, when it is determined that a detailed description of related known technologies may unnecessarily obscure the gist of the present disclosure, the detailed description will be omitted.

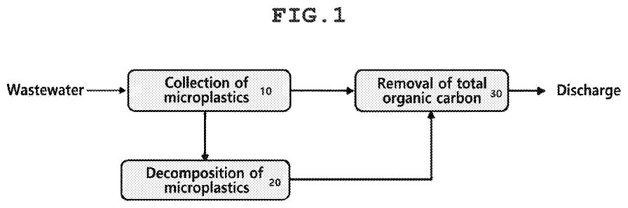

Referring to FIG. 1, a process for collecting and removing microplastics in wastewater according to an embodiment of the present disclosure is provided, the process including:

an operation of collection the microplastics 10, decomposing the microplastics 20 into their monomer constituents, removing the organic carbon from the waste water 30, and discharging the cleaned wastewater. The operation of the collection includes coagulating the microplastics into larger coagulated particles.

In an embodiment the process comprises: coagulating the microplastics inside the wastewater, and then adding an enzyme to the coagulated microplastics for decomposing the coagulated microplastics into their constituents. The coagulation of the microplastics is a treatment in which microplastics dispersed in wastewater are gathered to form aggregates of a certain size or larger, and the addition of the enzyme is a treatment in which the coagulated microplastics are decomposed by the enzyme.

According to an embodiment of the present disclosure, the microplastics in wastewater may be derived from alkali hot washing of PET plastics. The microplastics can include crystalline plastics used in beverage bottles as well as amorphous plastics used in disposable packs. Among the plastic types, amorphous plastics are decomposed very quickly by an enzyme without any separate pretreatment while crystalline plastics can be easily decomposed by the enzyme when the crystalline plastics are heat-treated before being decomposed by the enzyme. As described above, the microplastics in wastewater derived from the alkali hot washing of PET plastics have already been exposed to high temperatures under alkaline conditions during the hot washing process of PET plastics. Thus, in the subsequent microplastic decomposition process, the microplastics contained in wastewater can be easily removed without any additional heating treatment. The alkali used for the alkali hot washing of PET plastics may be selected from NaOH and KOH, and the alkali hot washing may be performed at a temperature in a range of 50° C. to 90° C.

According to an embodiment, the process may further include heat-treating the wastewater or microplastics in wastewater as a pretreatment. As used herein, the term “pretreatment” refers to treatment operations on wastewater prior to introduction into a process according to embodiments of the present disclosure. As mentioned above, the microplastics in wastewater may include crystalline plastics, and the heat treatment allows these crystalline plastics to be rapidly decomposed by an enzyme. In another embodiment, the wastewater introduced into the heat-treatment of wastewater as a pretreatment may be wastewater that has not undergone the alkali hot washing of PET plastics.

According to an embodiment of the present disclosure, the heat-treatment may be performed at a temperature in a range of 50° C. to 90° C. When the heat-treatment temperature is less than 50° C., the crystalline plastics may not be decomposed quickly by an enzyme because the crystalline plastics are not deformed. When the heat-treatment temperature exceeds 90° C., the degree of amorphization of the crystalline plastics is minimal relative to the energy required for heating, so it is not energy efficient. In an embodiment of the present disclosure, the heat-treatment may be performed at a temperature in a range of 55° C. to 85° C., or 70° C. to 80° C.

According to an embodiment, the coagulation of the microplastics in wastewater may be performed by electro-coagulation or the introduction of a coagulant. The electro-coagulation is a method of coagulating the microplastics in wastewater. The electro-coagulation may be achieved by supplying direct current or alternating current to electrodes connected to a power source. The coagulant may be created through a redox reaction that occurs on the surfaces of the cathode and anode of the electrodes. In addition to the electro-coagulation, any method of coagulating the microplastics by directly introducing the coagulant to wastewater, or any other method that can coagulate the microplastics in wastewater, may be used.

According to an embodiment, the cathode used for the electro-coagulation may contain any one selected from Steel Use Stainless (SUS), Fe, Al, and Pt, and combinations thereof. The cathode may be a reduction electrode that is reduced when power is supplied. The cathode should not elute and be consumed even when power is supplied. Considering economic efficiency, the cathode is preferably an inexpensive metal. In other words, the material used as the cathode must have dissolution stability in the electrolyte and be inexpensive. Accordingly, in an embodiment, the cathode may include any one selected from SUS, Fe, Al, and Pt, and combinations thereof.

According to an embodiment, the anode used for the electro-coagulation may contain any one selected from Fe, Al, and a combination thereof. The anode is a consumable electrode. In other words, the metal ions contained in the anode may be eluted through an oxidation reaction when power is supplied. The metal ions eluted from the anode may form hydroxides, which may act as a coagulant for the microplastics. The metal used as the anode is eluted as metal ions when power is supplied, and the metal is oxidized in water to form metal hydroxides. As long as the metal hydroxides meet each other and crystallize to function as a coagulant, there are no restrictions on the type of the metal hydroxides. For example, in one embodiment, the metal may include a highly reactive metal such as Fe, Al, and a combination thereof.

According to an embodiment, the electro-coagulation may be performed at a current density in a range of 5 mA/cm² to 20 mA/cm² for a hydraulic retention time (HRT) of 10 minutes to 30 minutes. In this way, in the case of electro-coagulation under constant current conditions of a specific current density, the applied voltage can be lowered. However, a long HRT is required for sufficient coagulation of the microplastics.

According to an embodiment, the electro-coagulation may be performed at a voltage in a range of 25 V to 200 V for a hydraulic retention time (HRT) of 2 seconds to 30 seconds. In electro-coagulation under constant voltage conditions, a high voltage may be applied to ensure sufficient coagulation reaction even with a short HRT.

According to an embodiment of the present disclosure, the introduced coagulant may include alum. There is no limit to the coagulant used in wastewater as long as it can coagulate the microplastics. For example, Poly aluminum chloride (PAC) may also be used as an coagulant.

According to an embodiment, the microplastics may have a size in a range of 1 μm to 5 mm based on the longest dimension. When the microplastics exceed 5 mm based on the longest dimension, the microplastics can be collected by gravity sedimentation without coagulation treatment, so collecting and removing the microplastics through the process is not cost-effective. When the microplastics have a size less than 1 μm based on the longest dimension, the electro-coagulation efficiency is low, so an excessive amount of enzymes is required to be added to ensure that the uncoagulated microplastics are decomposed by contact with the enzymes. When each microplastic has a size in a range of 1 μm to 5 mm, most of the microplastics dispersed in wastewater, for example, about 99% of the microplastics, are determined to have formed aggregates in the electro-coagulation. In this way, when the microplastics in wastewater are sufficiently coagulated, the volume of the microplastics that are required to be decomposed by enzymes is reduced. Thus, the amount of enzyme input for decomposition can be reduced. In an embodiment, the microplastics may preferably have a size in a range of 10 μm to 4 mm, or 25 μm to 3 mm, based on the longest dimension.

According to an embodiment, an enzyme may include at least one selected from the group consisting of PETases, esterases, lipases, and cutinases. The enzymes may be obtained from Humicola insolens, Fusarium solani pisi, Fusarium oxysporum, Penicillium citrinum, Pseudomonas mendocina, and Thermobifida species. The examples for the enzyme are all capable of hydrolyzing PET.

According to an embodiment, the addition of the enzyme may be performed at a temperature in a range of 25° C. to 80° C. and under a pressure in a range of 0.5 atm to 2 atm. For example, the addition of the enzyme to the coagulated microplastics may be performed at a temperature in a range of 35° C. to 70° C., or 40° C. to 60° C. The addition of the enzyme to the coagulated microplastics may be performed under a pressure in a range of 0.8 atm to 1.5 atm, or 1 atm to 1.2 atm.

According to an embodiment of the present disclosure, in the case of the addition of the enzyme to the coagulated microplastics, the weight ratio of the microplastics and enzyme may be in a range of 3:1 or more. When the weight ratio is less than 3:1, the amount of the enzyme is small relative to the microplastics, so the decomposition reaction of the microplastics by the enzyme may not proceed smoothly.

According to an embodiment of the present disclosure, after the decomposition of microplastic by the addition of enzyme, the decomposed microplastic may be fed to a biological treatment tank. Also, The electro-coagulated wastewater supernatants obtained after the operation of collection the microplastics may be fed to the biological treatment tank. By this treatment, total organic carbon (TOC) of the wastewater can be reduced.

Hereinafter, various examples are presented to facilitate understanding of the present disclosure. However, the following examples are provided only to facilitate an easier understanding of the present disclosure, and the present disclosure is not limited thereto.

### Example 1: Coagulation and Collection of Microplastics Using Electro-Coagulation

500 ml of wastewater derived from alkali hot washing of PET plastics was added to an electro-coagulation reactor. SUS with a size of 45 mm×150 mm×0.3 mm was placed as a cathode, and aluminum with a size of 45 mm×150 mm×0.8 mm was placed as an anode. Power connected to the cathode and anode was supplied at a current density of 12 mA/cm². With power supplied, the aluminum hydroxide eluted from the anode and the microplastics in the wastewater were stirred at a speed of 200 rpm so that the aluminum hydroxide and microplastics are evenly contacted and coagulated. This process was performed for a hydraulic retention time (HRT) of 20 minutes. The number of microplastics per volume of wastewater before and after electro-coagulation were analyzed by using Thermo iN10X Imaging IR (Ultra-fast Mapping mode Transmission, Imaging, Scan 1, Resolution 16). The result of the above analysis is shown in Table 1 below. The microplastic collection rates were compared and analyzed for two processes-one utilizing alum as a coagulant, and the other employing electro-coagulation. The comparison was conducted using 500 ml of wastewater. The result of the above analysis is shown in Table 1 below.

TABLE 1

| | Number of | |
|---|---|---|
| | microplastics | |
| | (PET) | Collection |
| | (Number/L) | rate |
| Wastewater before electro-coagulation | 24000 | — |
| Wastewater after electro-coagulation | 318 | 98.7% |
| Wastewater after chemical coagulation | 4900 | 79.6% |

When microplastics are coagulated by electro-coagulation, most microplastics in wastewater are collected, resulting in a high coagulation rate of 98.7%. Meanwhile, wastewater subjected to chemical coagulation treatment had a lower collection efficiency compared to wastewater subjected to electro-coagulation treatment.

### Example 2: Decomposition and Removal of Collected Microplastics by Enzymes

The electro-coagulated wastewater obtained in Example 1 was naturally sedimented for 2 hours for allowing solids to separate from the supernatants. After adding 300 μl (microliter) of Novozyme 51032, which was a type of lipase as a PET decomposition enzymeand 150 μl of potassium phosphate buffer (pH 7.0) to 300 mg of the obtained solid material (collected microplastics), the solid material was decomposed at a temperature of 50° C. for 7 days. The concentration of terephthalic acid (TPA), which was a decomposition product, was measured using high-performance liquid chromatography (HPLC). The ‘enzyme-treated PET standard material’ of Table 2 refers to microplastics with a size less than 425 μm, 50 mg that was subjected the above treatment.

TABLE 2

| | TPA detection |
|---|---|
| | concentration |
| | (ug/g) |
| Microplastics collected | Not detected |
| when not treated with enzymes | |
| Microplastics collected | 877 |
| when treated with enzymes | |
| Enzyme-treated PET standard material | 2767 |
| (with a size less than 425 μm, 50 mg) | |

As shown in Table 2, the microplastics collected by electro-coagulation were decomposed, and as a result terephthalic acid, which was a decomposition product, was detected. From this, it was confirmed that decomposition and removal were possible by adding an enzyme to the collected microplastics.

The present disclosure has been described in detail above through specific examples. The examples are provided for specifically explaining the present disclosure, and the present disclosure is not limited thereto. It will be clear that modifications and improvements can be made by those skilled in the art within the scope of the present disclosure.

It should be understood that the skilled person in this art will envision other embodiments and modifications or changes of the example embodiments described in the present disclosure that fall within the scope of the present invention as defined in the appended claims.

What is claimed is:

1. A process for collecting and removing microplastics in wastewater, the process comprising:
coagulating microplastics in wastewater, and
adding an enzyme to the coagulated microplastics.

2. The process of claim 1, wherein the wastewater originates from alkali hot washing of polyethylene terephthalate (PET) plastics.

3. The process of claim 1, further comprising heat-treating the wastewater or the microplastics as a pretreatment.

4. The process of claim 1, wherein the coagulation of the microplastics is performed by electro-coagulation or adding a coagulant.

5. The process of claim 4, wherein a cathode used for the electro-coagulation comprises any one selected from stainless steel (SUS), Fe, Al, and Pt, and combinations thereof.

6. The process of claim 4, wherein an anode used for the electro-coagulation comprises any one selected from Fe and Al, and a combination thereof.

7. The process of claim 4, wherein the electro-coagulation is performed at a current density in a range of 5 mA/cm² to 20 mA/cm² for a hydraulic retention time (HRT) of 10 minutes to 30 minutes.

8. The process of claim 4, wherein the electro-coagulation is performed at a voltage in a range of 25 V to 200 V for a hydraulic retention time (HRT) of 2 seconds to 30 seconds.

9. The process of claim 1, wherein the microplastics have a size in a range of 1 μm to 5 mm based on the longest dimension.

10. The process of claim 1, wherein the enzymes comprise at least one selected from the group consisting of PETases, esterases, lipases, and cutinases.

11. The process of claim 1, wherein the enzyme is added to the coagulated microplastics a temperature in a range of 25° C. to 90° C. and under a pressure in a range of 0.5 atm to 2 atm.

12. The process of claim 1, wherein the microplastics are PET microplastics and a weight ratio of the PET microplastcis a and of the enzyme in in the introduction of the enzyme is in a range of 3:1 or more.

13. A method for collecting and removing microplastics, the process comprising:
pulverizing polyethylene terephthalate (PET) bottles into microplastics;
dispersing the microplastics into a water system;
coagulating the microplastics to produce coagulated microplastics; and
adding an enzyme to the coagulated microplastics whereby the coagulated microplastics are decomposed by the enzyme into their monomer constituents.

14. The method of claim 13, further including:
washing the PET bottles with alkali solution at a temperature ranging from 50° C. to 90° C. before pulverizing the PET bottles.

15. The method of claim 13, further including:
heat-treating the microplastics before adding the enzyme to the coagulated microplastics.

16. A process for decomposing PET microplastics in wastewater into their constituent monomers, the process comprising:
introducing the wastewater with the PET microplastics in a electro-coagulator and subjecting to PET to electro-coagulation coagulating the PET microplastics inside the wastewater, and
adding PETas enzyme into the wastewater inside the electro-coagulator, and
the PETase enzyme decomposing the PET coagulated microplastics into their constituent monomers.

17. The process of claim 16, further comprising removing the constituent components of the PET microplastics from the wastewater.

18. The process of claim 17, wherein the constituent components comprise ethylene glycol and terephthalic acid.
